(19) United States
(12) Patent Application Publication
(10) Pub. No.: US 2009/0222412 A1
(43) Pub. Date: Sep. 3, 2009

(54) FACET VISUALIZATION

(75) Inventors: Bongshin Lee, Issaquah, WA (US); Greg Smith, Bellevue, WA (US); George G. Robertson, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/039,856

(22) Filed: Feb. 29, 2008

(51) Int. Cl. G06F 17/30; G06F 7/00

(52) U.S. Cl. 707/3; 707/102; 707/E17.001; 707/E17.014

(57) ABSTRACT

A system described herein includes a receiver component that receives a dataset and defined relationships amongst data in the dataset, wherein the relationships are indicative of identities of a plurality of facets in the dataset, wherein each facet includes an item, and wherein items in a facet have a common attribute. The system further includes a renderer component that renders a first facet in the plurality of facets on a graphical user interface, wherein the first facet is rendered as a selectable graphical icon. Concurrently with rendering the first facet, the renderer component renders a second facet in the plurality of facets on the graphical user interface, wherein the second facet is rendered with respect to a linear attribute.

### BACKGROUND

In the recent past, computing devices have increased in functionality and storage capacity while decreasing in cost. Accordingly, more and more people have access to computing devices that are capable of performing a myriad of tasks. Example tasks include document creation and editing; photograph, audio and/or video creation and editing; tracking investments; creation and editing of presentations; Internet browsing; amongst many other tasks.

Furthermore, many individuals who create content are becoming interested in sharing such content with others. For example, many individuals that create videos now desire to share such videos with others, wherein the videos may be accessible by way of the Internet, for example. In another example, individuals that publish scholarly articles may wish to have such articles published and accessible to the entire world. Currently, web sites exist that are dedicated to hosting content that has been created by many different individuals.

To aid users in locating certain content amongst a large amount of content, various search tools have been designed. Most of these search tools are textual in nature, wherein a user proffers a textual query and items in a data repository are searched over using such textual query. These search tools typically include rankers that are designed to rank items such that relevant items are displayed more prominently to the user when compared to less relevant items. For certain data, however, these text-based search tools are suboptimal, as the user may not know an acceptable manner for formulating a query. If the user does not formulate a suitable query, desired content may not be provided to a user or may be ranked in a position where the user will never see the desired content.

In another example, the user may wish to search a database for an item without having a solid idea of an identity of the item. For instance, the user may wish to search a database of scholarly articles, but may be unaware of the title of the article and unable to recollect the name of the author of the article (but would recognize the name if presented). In such a situation, options of the user are limited and results of a search are typically undesirable. For example, the user may type in a query such as “author”, but such query would be unlikely to return a desired result.

In a further example, the user may wish to understand certain aggregate characteristics of the data that are not expressible by way of a targeted search. For example, a user may want to know which authors published the most articles in 2004, which is not an attribute of any one item in the database that can be searched for. Current tools which are optimized for targeted item search are inadequate for accomplishing these types of tasks.

### SUMMARY

The following is a brief summary of subject matter that is described in greater detail herein. This summary is not intended to be limiting as to the scope of the claims.

Various technologies pertaining to visualized searching for items in a dataset are described herein. A dataset may include several items, wherein items in the dataset are associated with metadata that describe attributes of the items. Based at least in part upon the metadata and attributes of items, certain items in the dataset may be grouped together in groupings of items. These groupings of items, referred to herein as “facets”, can be visually displayed on a graphical user interface and selected by a user, which may initiate visualization of “sub-facets” (further sub-groupings of attributes or items) that are defined by the facet.

Pursuant to an example, different facets (e.g., represented as selectable icons) can be rendered concurrently on a graphical user interface. For instance, a first facet can be represented as a selectable graphical icon, wherein selection of the first facet may cause presentation of a sub-facet or an item included in the facet. A second facet can be represented using multiple axes, wherein information is visually conveyed to the user by way of the multiple axes. More particularly, the second facet can be rendered so as to represent a first attribute that corresponds to the second facet (such as a number of items in the second facet) with respect to a second attribute (e.g., a linear attribute). For instance, the second facet may be rendered to illustrate a number of items in the second facet over certain periods of time (e.g., to illustrate a trend). In another example, the second facet may be rendered to illustrate a number of items in the second facet with respect to certain geographic locations.

In yet another example, items in the dataset and/or groupings of items in a particular facet may be searched over using a textual query, and results of such query can be presented to the user in a list fashion. Thus, a combination of visual searching and textual querying can be used in connection with locating desired information.

In yet another example, items and/or facets can be highlighted if a cursor is detected as hovering over a particular item and/or facet. For instance, an item in a facet may be represented as a graphical icon, and a cursor may be positioned so as to hover over the graphical icon. Each instance of the item that is represented on the graphical user interface may be highlighted upon detection of a hover.

Other aspects will be appreciated upon reading and understanding the attached figures and description.

### BRIEF DESCRIPTION OF THE DRAWINGS

FIG. 1 is a functional block diagram of an example system that facilitates rendering various facets on a graphical user interface.

FIG. 2 is a functional block diagram of an example system that facilitates searching for information by way of textual queries.

FIG. 3 is a functional block diagram of an example system that facilitates generating a list of items.

FIG. 4 is a functional block diagram of an example system that facilitates highlighting instances of items in a graphical user interface.

FIG. 5 is a functional block diagram of an example system that facilitates filtering data from a dataset.

FIG. 6 is a functional block diagram of an example system that facilitates automatically determining an amount of information to present to a user.

FIG. 7 is a flow diagram that illustrates an example methodology for rendering differing facets concurrently on a graphical user interface.

FIG. 8 is a flow diagram that illustrates an example methodology for searching by way of selecting facets.

FIG. 9 is a flow diagram that illustrates an example methodology for highlighting instances of items on a graphical user interface.

FIG. 10 is a flow diagram that illustrates an example methodology for filtering a dataset.

FIGS. 11-18 are example graphical user interfaces.

FIG. 19 is an example computing system.

### DETAILED DESCRIPTION

Various technologies pertaining to a visual manner for searching for and locating content will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

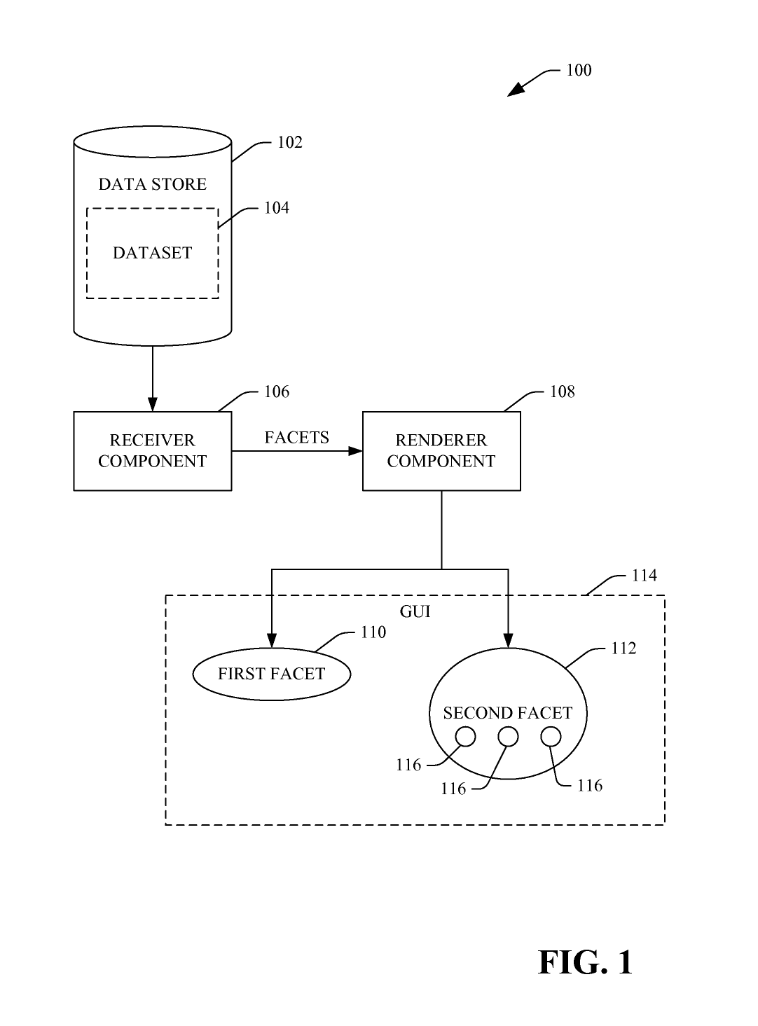

With reference to FIG. 1, an example system 100 that facilitates visualizing digital content is illustrated. The system 100 includes a data store 102 that comprises a dataset 104. Pursuant to an example, the dataset 104 may include items, metadata that describe the items (e.g., attributes of the items), and defined relationships between items. For instance, items in the dataset may be scholarly articles, wherein the scholarly articles have one or more particular authors, are published on a certain date, have specific subject matter, are sponsored by certain entities, have particular titles and/or subtitles, amongst other attributes. In another example, items in the dataset may be videos, wherein a video in the dataset may have metadata that describes a video recorder that created the video, an author or authors, a topic that corresponds to the video, a genre (e.g., thriller, comedy, . . . ), a resolution, amongst other attributes. In still yet another example, the dataset 104 may include different types of items (e.g., scholarly articles, videos, and audio files), wherein each item may be associated with metadata that describes the items.

The dataset 104 may also include defined relationships between items therein. For instance, the relationships may indicate which items are to be logically grouped together, wherein a grouping of items created by way of the defined relationships between items is hereinafter referred to as a “facet.” In an example, items in a facet may share at least one common attribute. In addition, it is to be understood that a grouping defined by a facet may include other sub-facets, and that a common item may be located by traversing through different facets and/or sub-facets.

To aid in explanation of facets, an example is provided herein. It is to be understood, however, that such example is intended for illustrative purposes only, and is not intended to limit the scope of the hereto-appended claims. As noted above, items in the dataset 104 may include scholarly articles and metadata corresponding thereto. Accordingly, a first facet may facilitate filtering of the dataset 104 based at least in part upon names of authors and a second facet may facilitate filtering of the dataset 104 based at least in part upon the topics of articles. Accordingly, a user may select an author name grouping within the first facet, which facilitates further filtering of the dataset based on other attributes of papers authored by the selected author within other facets or sub-facets, such as names of co-authors or other information. In another example, the user may select a topic value within the second facet, which facilitates further filtering the dataset based at least in part upon names of authors with articles in that topic, for example. It can be ascertained, then, attributes can be grouped into multiple orthogonal categories, and such categories can be facets.

The system 100 further includes a receiver component 106 that receives a subset of the dataset 104 and the defined relationships therein. As discussed above, the relationships are indicative of identities of facets in the dataset 104, and each facet includes at least one item. A renderer component 108 receives facets from the receiver component 106 and concurrently renders a first facet 110 and a second facet 112 on a graphical user interface 114.

The first facet 110 may be rendered on the graphical user interface 114, and may be displayed as including other facets or as being included in another facet. The second facet 112 may also be displayed on the graphical user interface 114, wherein at least one attribute of the second facet 112 (e.g., a number of items in the facet, a number of items that have a particular topic, a number of items that have a certain author, . . . ) is displayed with respect to another attribute. In a specific example, at least one of the attributes may be a linear attribute, such as time or space. For example, the second facet 112 may illustrate a number of items or a number of items with a certain attribute or attributes 116 with respect to time. In another example, the second facet 112 may illustrate a number of items or a number of items with a certain attribute or attributes with respect to spatial location. It is understood, however, that items or attributes may be displayed with respect to any suitable attribute. For instance, any suitable attribute may be assigned to be a linear attribute, and can be selected by a user. Pursuant to an example, items in the dataset 104 may be scholarly articles that have a variety of topics. Accordingly, a facet directed to topics may be illustrated as a bar graph that graphically illustrates a number of items in a plurality of topics (e.g., a height of a bar in the bar graph can be indicative of a number of items that correspond to a certain topic). In this example, a topic attribute can be selected by the user as being a linear attribute.

In a specific example, items in the dataset 104 may be scholarly articles, the first facet 110 may facilitate filtering by topic of the articles, and the second facet 112 may illustrate a number of items in the dataset 104 with respect to time (e.g., a number of items per year). In yet another example, the second facet 112 may illustrate an attribute over another attribute, such as topics of articles with respect to time.

As will be shown in greater detail below, the graphical user interface 114 can be presented to a user. The user may, for instance, select the first facet 110 to filter the dataset 104 such that items that are not included in the first facet 110 (e.g., items that do not include an attribute that defines the first facet 110) are filtered from the dataset 104 and are not presented to the user. Selection of the first facet 110 may cause another graphical user interface to be presented to the user, wherein such interface may include other facets that can be used to further filter the dataset 104 and/or may include items that are in these facets. An item or items can be searched for and located in a visual manner through use of facets.

In another example, the user may select the first facet 110 (which includes a plurality of items), and the renderer component 108 may render a subset of items that correspond to the first facet concurrently with trend information pertaining to such items. For instance, items corresponding to the first facet 110 may be displayed as a list, and such list of items may be displayed concurrently with an indication of how such items relate to particular periods of time (e.g., months, years, or other suitable period of time).

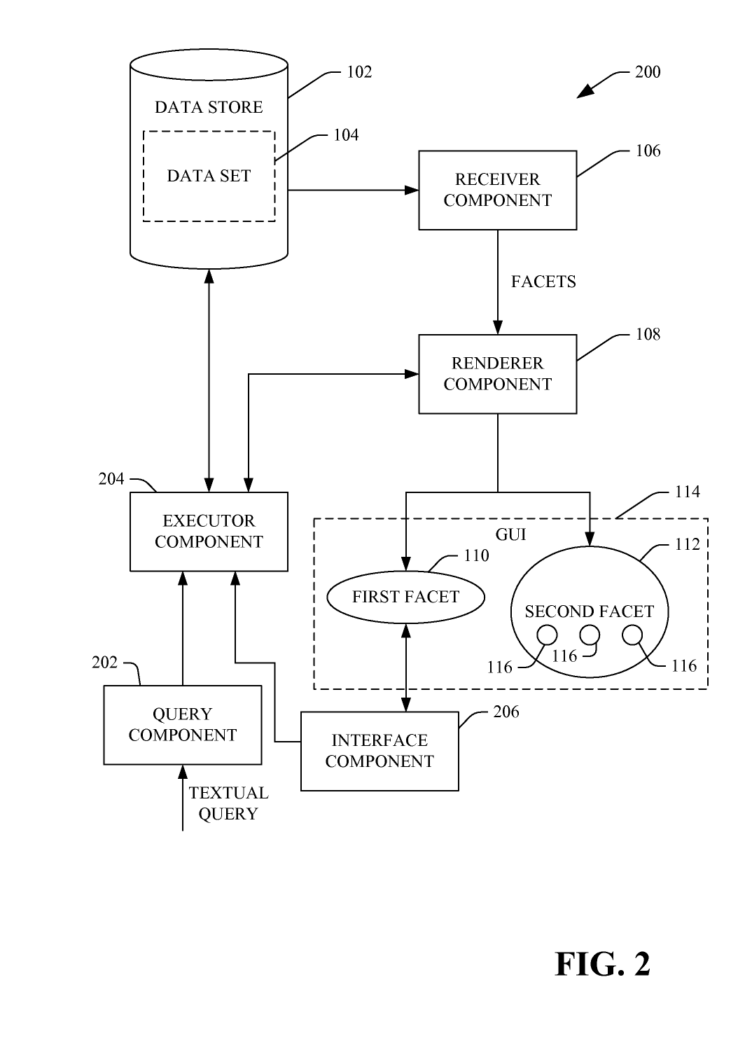

Referring now to FIG. 2, an example system 200 that facilitates searching for information by way of facets is illustrated. The system 200 includes the data store 102, the dataset 104, the receiver component 106, and the renderer component 108, which operate as described above in connection with concurrently rendering the first facet 110 and the second facet 112 on the graphical user interface 114.

The system 200 further includes a query component 202 that receives a textual query from a user that is searching for one or more items in the dataset 104. The textual query may be a Boolean query, a natural language query, or any other suitable type of textual query. An executor component 204 may receive the textual query and search the dataset 104 for attributes and/or items using the textual query. Attributes and/or items located by the executor component 204 may be provided to the renderer component 108, which can render a subset of the located attributes and/or items on the graphical user interface 114 (e.g., as a facet or as an item). The located attributes and/or items may be rendered concurrently with one or more facets (e.g., the first facet 110 and/or the second facet 112).

The system 200 may also include an interface component 206 that receives a user selection of at least one facet that is rendered on the graphical user interface 114. In this example, the selected facet is illustrated as being the first facet 110. It is to be understood, however, that any facet or sub-facet rendered on the graphical user interface 114 may be selected by the user. The query component 202 may receive a textual query from the user, and the executor component 204 may execute the query against attributes and/or items in the selected facet (rather than the entirety of the dataset 104). Pursuant to an example, a facet rendered on the graphical user interface 114 may include an icon that causes a query field to be presented, wherein entrance of a query into the query field is used to search the facet for attributes and/or items. An example graphical user interface depicting such features is provided herein.

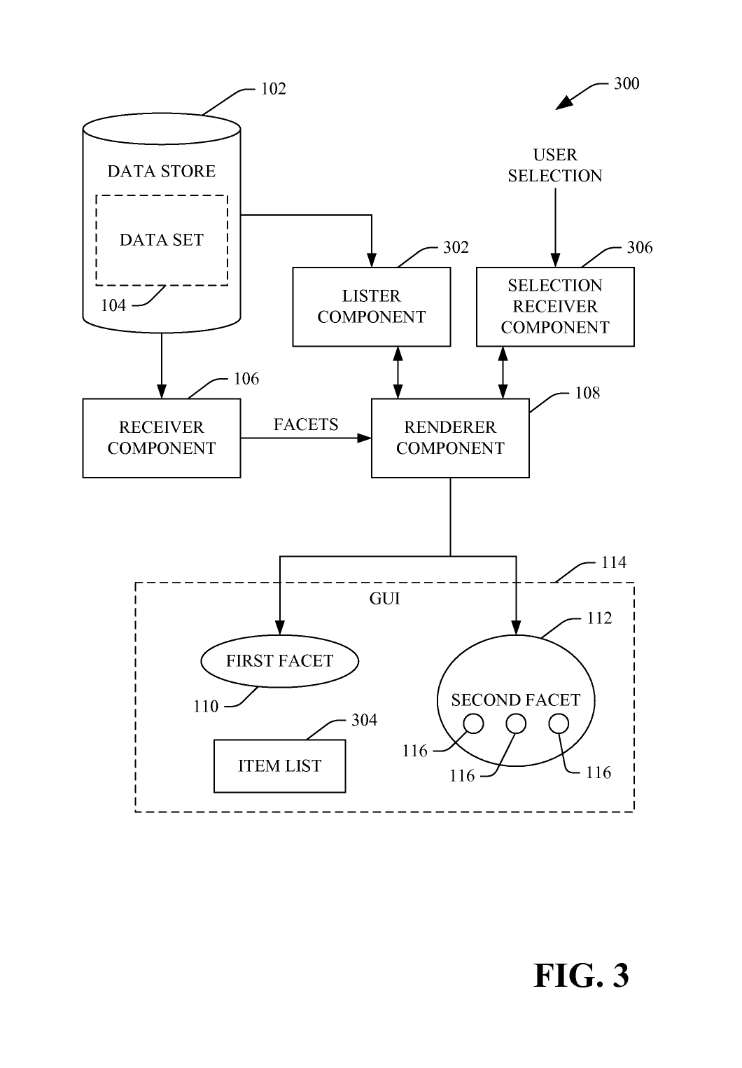

Referring now to FIG. 3, an example system 300 that facilitates searching for items in a dataset by way of visualized facets is illustrated. The system 300 includes a lister component 302 that can generate a list of items in the data set 104. The renderer component 108 may render the list as a list of items 304 on the graphical user interface 114. In an example, the renderer component 108 may render the list of items 304 on the graphical user interface 114 concurrently with the first facet 110 and/or the second facet 112.

The system 300 further includes a selection receiver component 306 that is configured to receive a user selection of a facet on the graphical user interface 114 or an item in the list of items 304. Pursuant to an example, the selection receiver component 306 can receive an indication that a user desires to select the first facet 110, and the first facet 110 may include a plurality of sub-facets. In response to the indication received by the selection receiver component 306, the renderer component 108 can render a subset of the plurality of sub-facets of the first facet 110 on the graphical user interface 114.

In another example, the selection receiver component 306 can receive an indication from a user that the user wishes to select an item in the list of items 304. In response to such indication, the renderer component 108 can render the item and details pertaining thereto on the graphical user interface 114.

In yet another example, the selection receiver component 306 can receive an indication from a user that an attribute of the second facet 112 is desirably selected. For instance, the second facet 112 may illustrate a number of items with respect to certain time periods. The user may wish to select a certain time period (e.g., a certain year). In response to the received indication, the renderer component 108 can render items and/or facets corresponding to the selected attribute on the graphical user interface 114.

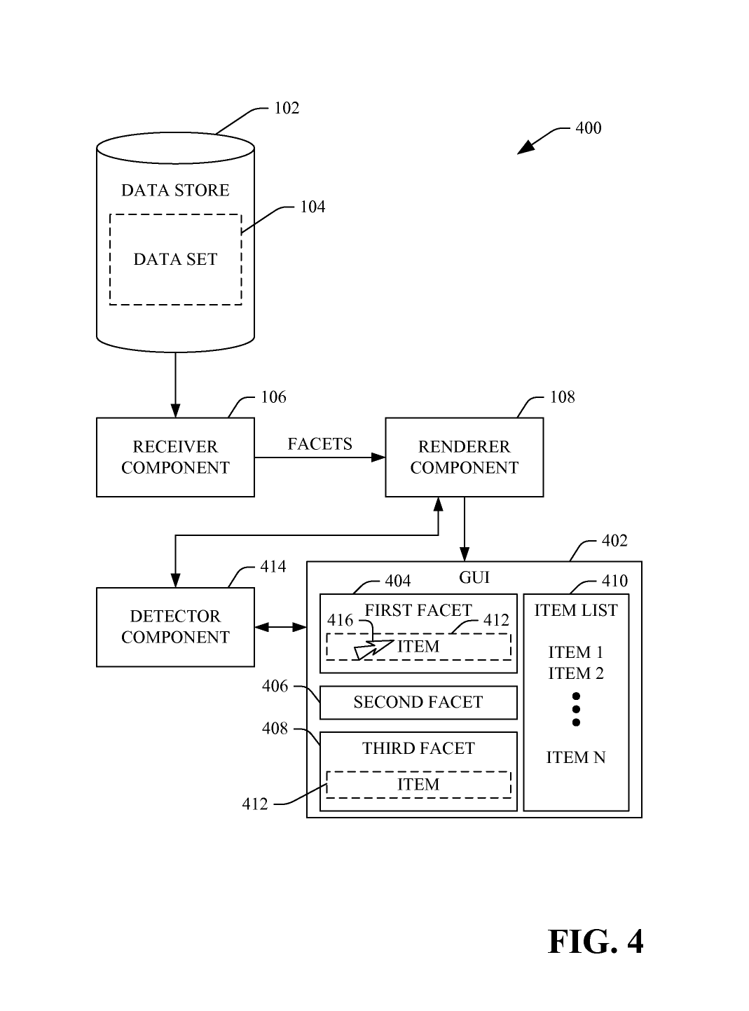

Turning now to FIG. 4, an example system 400 that facilitates locating items is illustrated. The system 400 includes the data store 102, the dataset 104, and the receiver component 106 which operate as described above. The system 400 further includes the renderer component 108 that can render a plurality of facets and sub-facets in a graphical user interface 402. In this example, the facets rendered by the renderer component 108 in the graphical user interface 402 include a first facet 404, a second facet 406, and a third facet 408. In addition, the renderer component 108 can display a list of items 410 in the graphical user interface 402, wherein the list of items 410 may correspond to a selected facet, for instance.

In addition to rendering facets, the renderer component 108 can render graphical icons that are representative of items in facets. In the example system 400, the renderer component 108 may represent a first item 412 in the first facet 404 and the third facet 408, wherein such item 412 is represented by a graphical icon in the facets 404 and 408.

The system 400 optionally includes a detector component 414 that can detect that a graphical icon (representing an item) rendered by the renderer component 108 is being hovered over by, for instance, a cursor 416. In response to a detection by the detector component 414, the renderer component 108 can highlight each representation of the item that is rendered on the graphical user interface 402. For example, a representation of the item in the first facet 404, a representation of the item in the third facet 408, and a representation of the item (e.g., a textual representation) in the list of items 410 can be highlighted. Highlighting may include providing a “halo” of color around each instance of the item. In another example, highlighting may include rendering text or graphics in a darker shade when compared to non-lighted portions of the graphical user interface 402. Any suitable manner of highlighting instances of items is intended to fall under the scope of the hereto-appended claims.

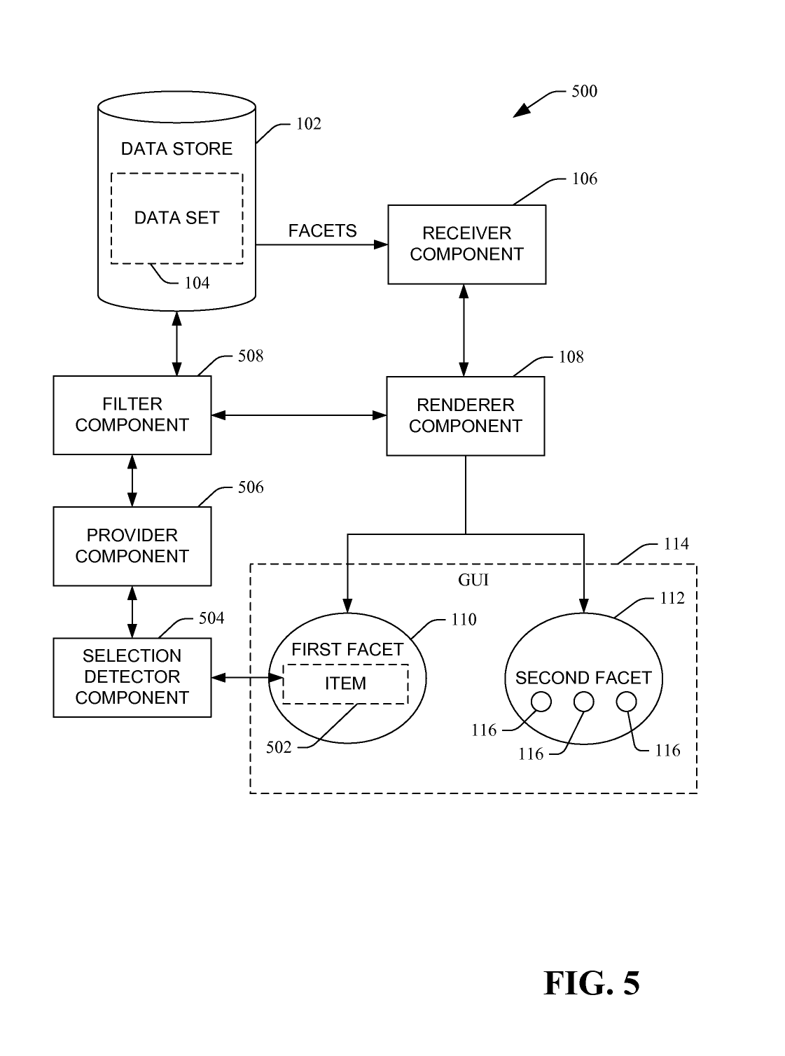

Referring now to FIG. 5, an example system 500 that facilitates displaying an item to a user is illustrated. The system 500 includes the data store 102, the dataset 104, the receiver component 106, and the renderer component 108, which act in conjunction as described above in connection with rendering the first facet 110 and the second facet 112 in the graphical user interface 114. Furthermore, the renderer component 108 can render a graphical representation of an item 502 in a facet (e.g., the first facet 110).

A selection detector component 504 can detect that the item 502 (e.g., the graphical representation) has been selected by a user. For instance, the user may select the item 502 by way of a pointing and clicking mechanism, voice command, and/or the like. A provider component 506 can analyze the selected item 502 and output one or more attributes of the item 502 that may be used as search filters over the dataset 104. For instance, the item may be a scholarly article that is written by several authors. The provider component 506 may output identities of the authors. Such attributes may be used as a search filter over the dataset 104. In an example, a user can select an attribute output by the provider component 506, and a filter component 508 can filter that dataset 104 using the selected attribute. The filter component 508 can output a filtered dataset to the renderer component 108, which can then render facets and/or items in the filtered dataset in the graphical user interface 114.

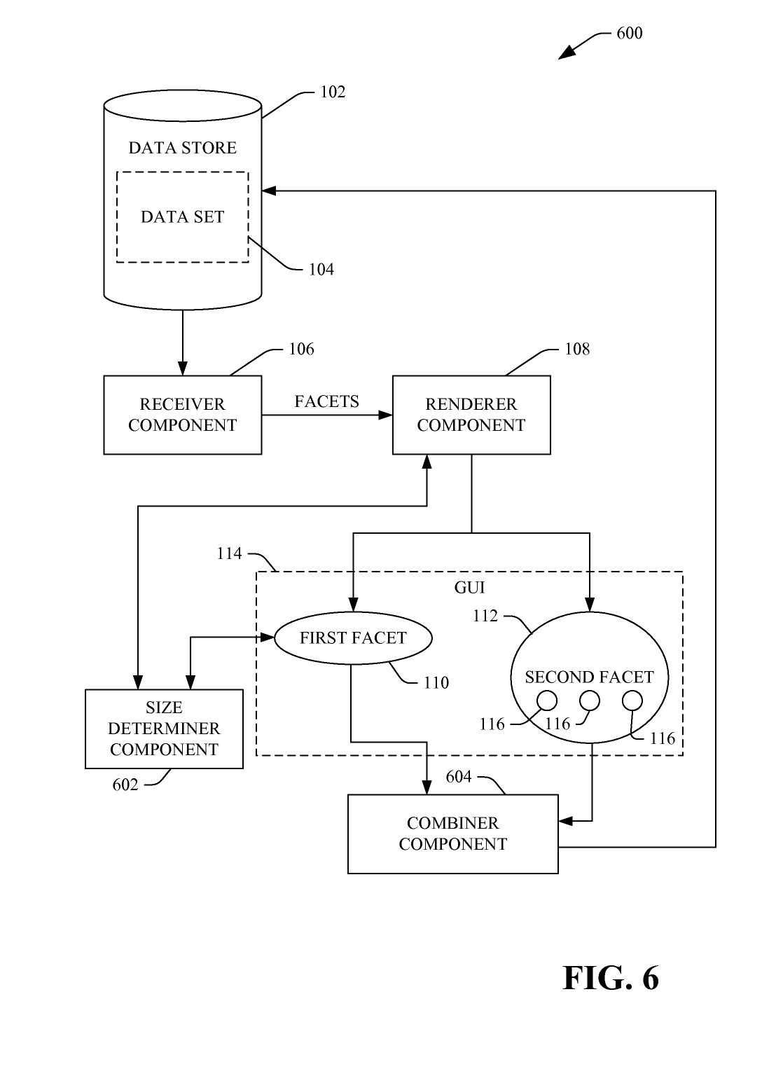

Referring now to FIG. 6, an example system 600 that facilitates searching for items in a dataset is illustrated. The system 600 includes the data store 102, the dataset 104, the receiver component 106, and the renderer component 108, which act in conjunction as described above. The system 600 further includes a size determiner component 602 that determines an amount of real-estate on the graphical user interface 114 that is used to display facets. For instance, the size determiner component 602 can determine and output an amount of display screen real estate that is utilized to display the first facet 110. The renderer component 108 can receive data from the size determiner component 602 and can determine an amount of information to render with respect to facets based at least in part upon such data. The size determiner component 602 may determine that the first facet 110 will use approximately thirty percent of display screen real-estate. Based at least in part upon such information, the renderer component 108 can render certain details pertaining to the first facet 110 with the first facet 110, such as render sub-facets in the first facet 110, render attributes used in connection with the first facet 110, and/or the like. In addition, while not shown, the size determiner component 602 can determine an amount of display screen real estate that is used to display items, and the renderer component 108 can render details pertaining to the items based at least in part upon the determined amount of display screen real estate.

The system 600 can also include a combiner component 604 that receives an indication that a user has selected one facet and dragged it over another facet (e.g., click and drag). In an example, the combiner component 604 can determine that a user has selected the first facet 110 and dragged it over a portion of the linear attribute of the second facet 112. For instance, the second facet 112 may represent an attribute over time, and the user may drag the first facet 110 over a particular region of time displayed in connection with the second facet 112. The combiner component 604 can be used to filter contents of the first facet 110 by the portion of the aforementioned linear attribute of the second facet 112. Continuing with the above example, if the first facet 110 is dragged over a particular time period corresponding to the second facet 112, then contents of the first facet 110 may be filtered by the particular time period.

In another example, the combiner component 604 can “transform” the first facet 110 into a form that is consistent with that of the second facet. More specifically, the first facet 110 can be selected and dragged into a field that includes the second facet 112. In a particular example, the second facet 112 may visually depict a number of scholarly articles per year. The first facet 110 may be used to filter a dataset by topic of scholarly articles (e.g., the first facet 110 may be directed towards a particular topic). When the first facet 110 is dragged into a field that includes the second facet 112, the first facet 110 may be re-rendered with respect to the linear attribute used to visualize the second facet. Thus, the first facet 110 can be used to visualize a number of items in the dataset that are directed towards the particular topic per year. The re-rendered first facet 110 and the second facet 112 may be displayed in the field used to display the second facet (as will be shown below). In another example, a different (new pop-up) window can be rendered by the renderer component 108, and the re-rendered first facet 110 and the second facet 112 may be displayed in the different window.

In yet another example, the combiner component 604 can be employed in connection with “combining” facets that are rendered in a form consistent with the second facet 112. For instance, the dataset may include scholarly articles, and a facet may be represented as a bar graph that illustrates a number of articles in a dataset over particular time periods (e.g., years). A different facet may be illustrated as a number of articles that correspond to certain topics. These two facets can be combined, which may result in multiple facets that illustrate a number of items in a particular topic over particular periods of time. The renderer component 108 can render facets resulting from combination of facets (as undertaken by the combiner component 604).

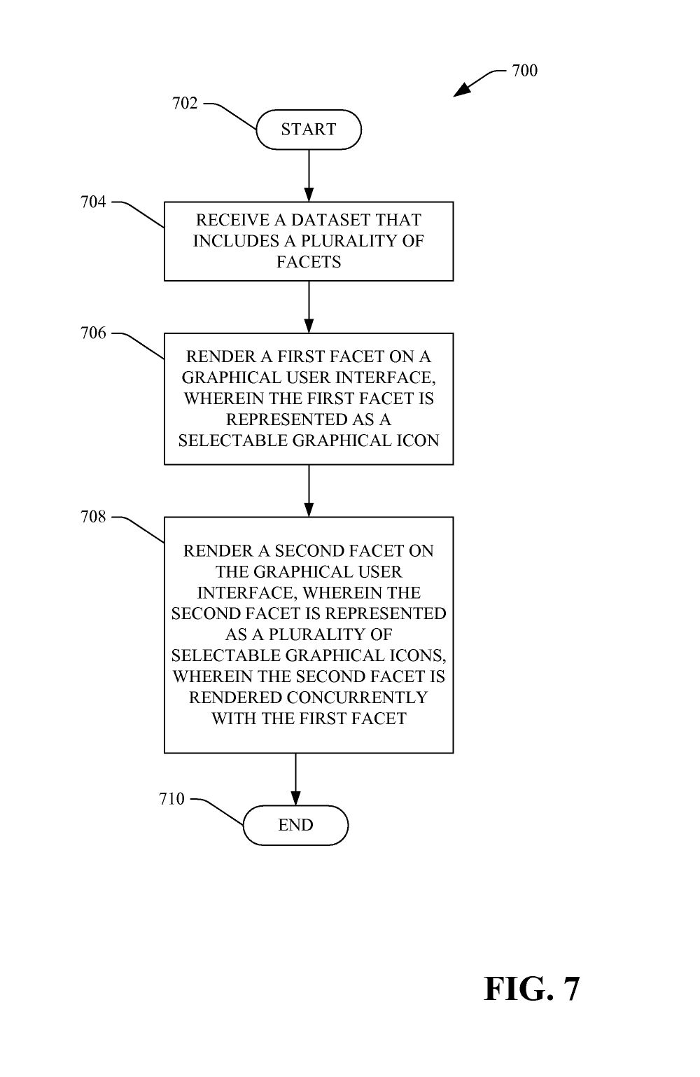

With reference now to FIGS. 7-10, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. Further, it is to be understood that at least some of the acts may be supplemented by functionality, acts, and/or features described above.

Referring specifically to FIG. 7, an example methodology 700 for concurrently rendering different facets on a graphical user interface is illustrated. The methodology 700 starts at 702, and at 704 a dataset that includes a plurality of facets is received. Each facet in the plurality of facets can include at least one item, and each item can include at least one attribute. In addition, items in a facet can share at least one common attribute.

At 706, a first facet is rendered on a graphical user interface, wherein the first facet is represented as a selectable graphical icon. For instance, the first facet may be rendered as a bubble that is selectable by way of a pointing and clicking mechanism, wherein the bubble is configured to present information pertaining to the facet to the user (such as title of the facet, sub-facets that reside in the facet, amongst other data). In another example, the first facet may be rendered as a selectable hyperlink, wherein hovering over the hyperlink causes information pertaining to the facet to be presented to the user. Other manners of rendering the first facet are contemplated and intended to fall under the scope of the hereto-appended claims.

At 708, a second facet is rendered on the graphical user interface, wherein the second facet is represented as a plurality of selectable graphical icons. In an example, the facet rendered at 706 and the facet rendered at 708 can be rendered concurrently on the graphical user interface. Pursuant to an example, the plurality of selectable graphical icons can represent at least one attribute of the second facet with respect to a linear attribute of the second facet. In an example, the linear attribute may be an attribute that is selected as being linear by the user. For instance, the linear attribute may be time, such that a certain attribute of the second facet is represented with respect to time. In another example, the linear attribute may be spatial location, such that a certain attribute of the second facet is represented with respect to time. In yet another example, the linear attribute may be topic, author, and/or the like. The methodology 700 completes at 710.

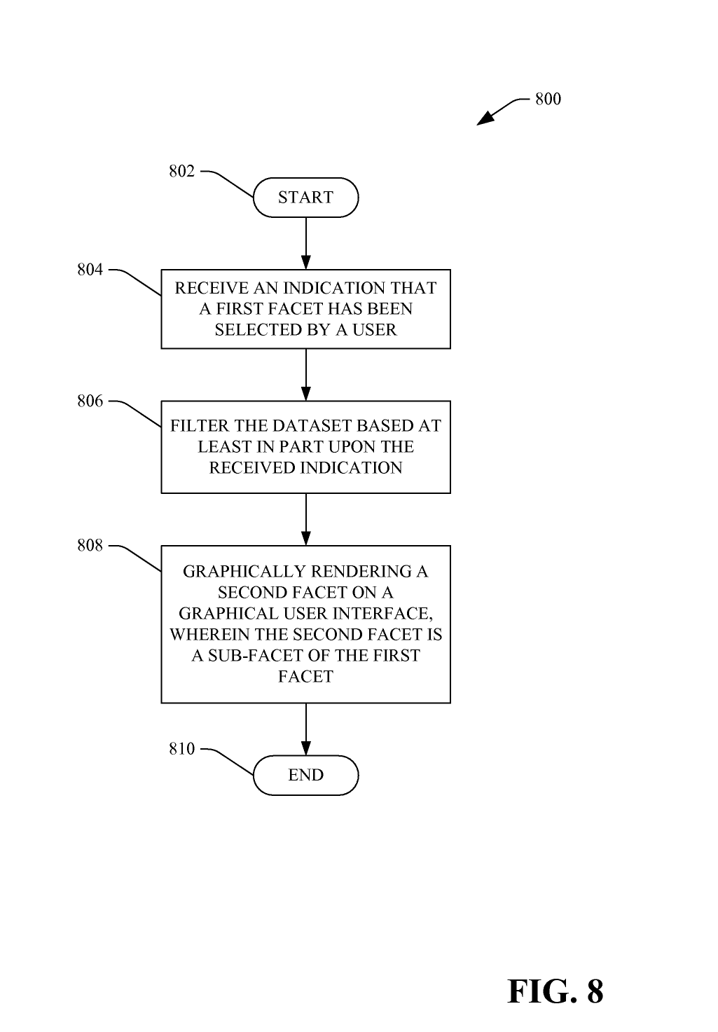

Turning now to FIG. 8, an example methodology 800 for rendering a sub-facet is illustrated. The methodology 800 starts at 802, and at 804 an indication that a user has selected a first facet is received. Such selection may be made by way of a pointing and clicking mechanism, a pressure-sensitive screen, and/or the like.

At 806, the dataset is filtered based at least in part upon the received indication. For instance, the dataset may include a plurality of videos, and the first facet may include items with a common topic. Upon selection of such facet, the dataset is filtered such that items/facets that do not include the topic are filtered from the user.

At 808, a second facet is graphically rendered on a graphical user interface in response to user-selection of the first facet, wherein the second facet is a sub-facet of the first facet. For instance, the second facet may include videos with a particular author. Thus, the second facet is representative of items of a certain topic generated by the particular author. The methodology 800 completes at 810.

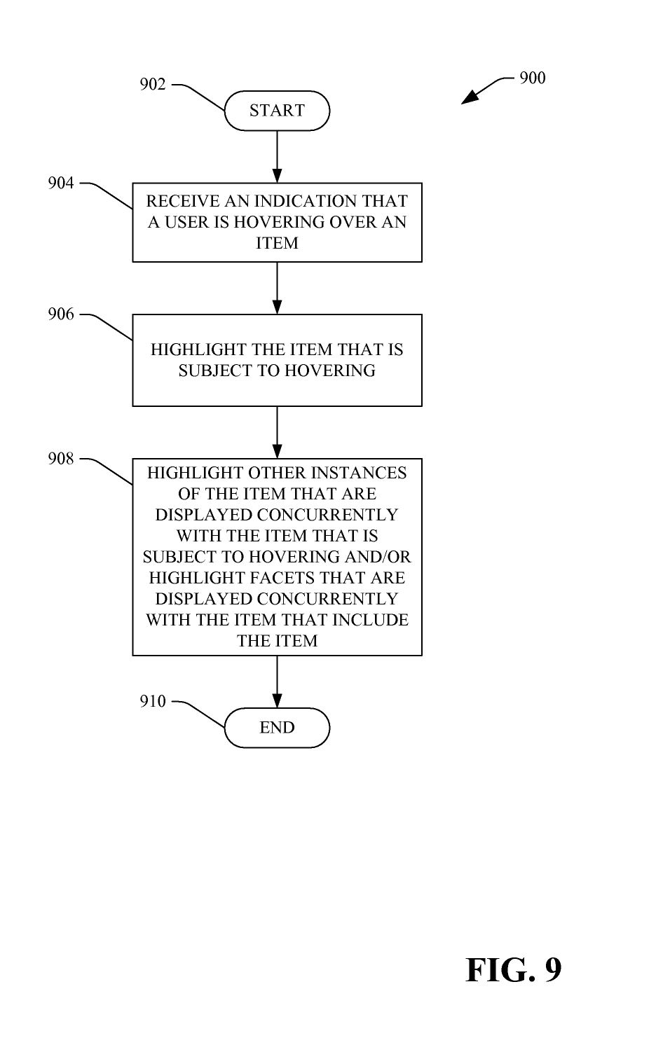

With reference now to FIG. 9, an example methodology 900 for presenting information to a user is illustrated. The methodology 900 starts at 902, and at 904 an indication is received that a user is hovering over an item (e.g., a graphical icon that represents the item) on a graphical user interface. For instance, the user may be hovering over the item with a cursor.

At 906, the item that is subject to hovering is highlighted. As noted above, highlighted can include rendering a ring of a particular color, such as yellow, around the item. Highlighting may also include rendering graphics and/or text more boldly when compared to other items that are not subject to highlighting.

At 908, other instances of the item that are displayed concurrently with the item that is subject to hovering are highlighted. Additionally or alternatively, facets that include the item that are displayed concurrently with such item can be highlighted.

In another example, when a detection is made that a cursor is hovered over a facet or sub-facet, other facets and/or sub-facets visually presented to the user can be highlighted based at least in part upon an amount of overlap with respect to items that correspond to the facets and/or sub-facets. For instance, a detection can be made that a first facet is hovered over and that a second facet has 90% similarity with respect to items that are covered by the first facet and second facet. The second facet can be color-coded a particular color based upon such overlap. The methodology 900 completes at 910.

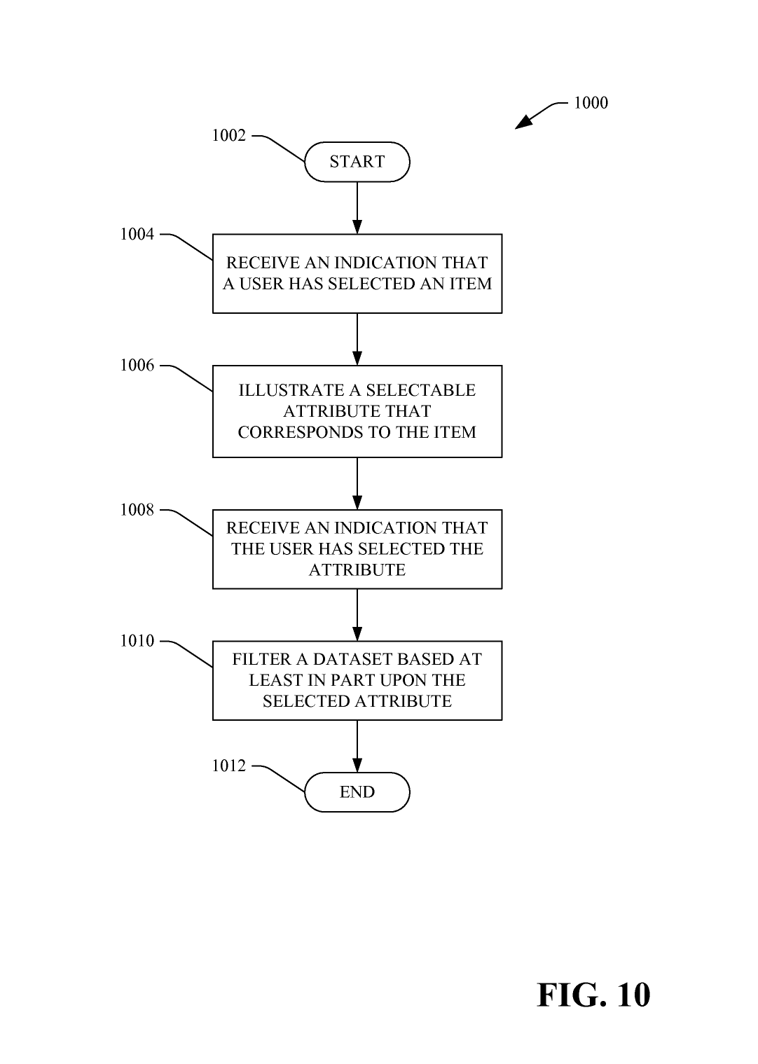

Now referring to FIG. 10, an example methodology 1000 for filtering a dataset is illustrated. The methodology 1000 starts at 1002, and at 1004 an indication is received that a user has selected an item on a graphical user interface. At 1006, a selectable attribute that corresponds to the item is illustrated. For instance, if the item is a scholarly article, an attribute such as “papers by author” can be provided to the user.

At 1008, an indication is received that the user has selected the attribute (e.g., by way of a pointing and clicking mechanism). At 1010, a dataset is filtered based at least in part upon the selected attribute. In practice, such methodology 1000 can be used to “pivot” about an attribute of a located item. The methodology 1000 completes at 1012.

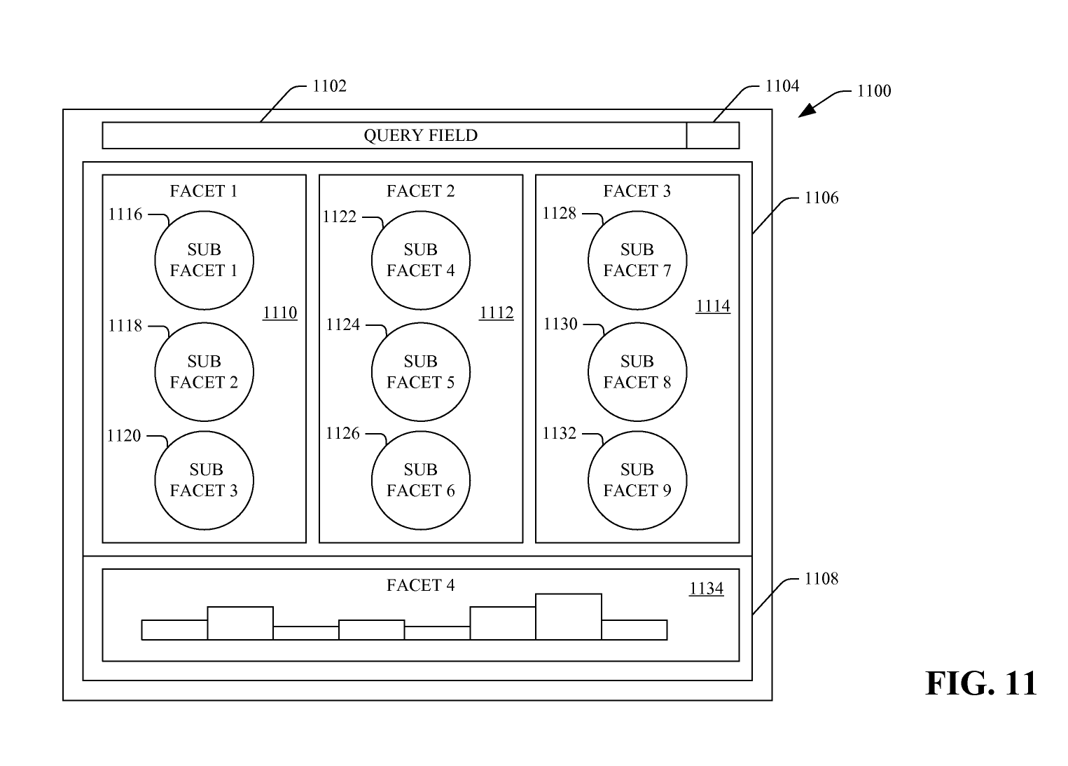

Referring collectively to FIGS. 11-18, various example graphical user interfaces that can be rendered by the renderer component 108 (FIGS. 1-6) are illustrated. Such graphical user interfaces may be depicted on a personal computer, a laptop computer, a personal digital assistant, a portable telephone, or other suitable display screen. Furthermore, it is to be understood that the example graphical user interfaces are provided for illustrative purposes as examples, and the scope of the claims is not to be limited by the depicted example interfaces.

Turning specifically to FIG. 11, an example graphical user interface 1100 that can be used in connection with visualizing facets is illustrated. The graphical user interface 1100 includes a query field 1102, wherein a user can provide a textual query into the query field 1102. The graphical user interface 1100 also includes a search button 1104, wherein depression of such search button 1104 when a query is provided in the query field 1102 may initiate a search over a dataset or a subset of the dataset using the query.

The graphical user interface 1100 is also depicted as including two facet fields 1106 and 1108. The first facet field 1106 is shown as including a first facet 1110, a second facet 1112, and a third facet 1114. The first facet 1110 is depicted as including three displayed sub-facets 1116, 1118, and 1120, the second facet 1112 is depicted as including three sub-facets 1122, 1124, and 1126, and the third facet 1114 is depicted as including three sub-facets 1128, 1130, and 1132. Each of the facets in the first facet field 1106 may include a grouping of items, wherein each item in a grouping of items shares at least one common attribute. In addition, facets in the first facet field 1106 are rendered as selectable graphical icons. If a user selects one of the facets in the first facet field 1106, items in a dataset are filtered based at least in part upon such selection (e.g., the dataset is filtered based at least in part upon the attribute that is common amongst items in a grouping of items corresponding to a selected facet).

With more specificity with respect to facets and sub-facets in the first facet field 1106, such facets and/or sub-facets 1110-1132 are displayed in a two-dimensional space. It can be discerned, however, that with respect to the first facet field 1106 the two-dimensional space is used to visualize the facets 1110-1114 and sub-facets 1116-1132 therein. In other words, the X-axis and Y-axis of the two-dimensional space are equivalent and are not utilized to encode additional information.

The second facet field 1108 includes a facet 1134 that is rendered as a plurality of selectable graphical icons, wherein each of the selectable graphical icons may be sub-facets. The facet 1134 corresponds to a grouping of items that share at least one common attribute. In this example interface 1100, the facet 1134 is rendered with respect to two attributes, wherein at least one of the attributes is linear. For instance, the facet 1134 may depict a number of items in a dataset with respect to time. In another example, items in the dataset may be scholarly articles, and the facet 1134 may depict topics of articles with respect to time. In yet another example, the facet 1134 may depict topics of articles with respect to location.

With more specificity regarding visualization of facets in the facet field 1108, the Y-axis of the two-dimensional space used to depict the facet 1134 encodes additional data pertaining to the facet 1134 and/or sub-facets. For instance, the facet 1134 may include several sub-facets that are based at least in part upon a linear attribute, such as time. The Y-axis can be used to encode information such as a number of items in each of the sub-facets.

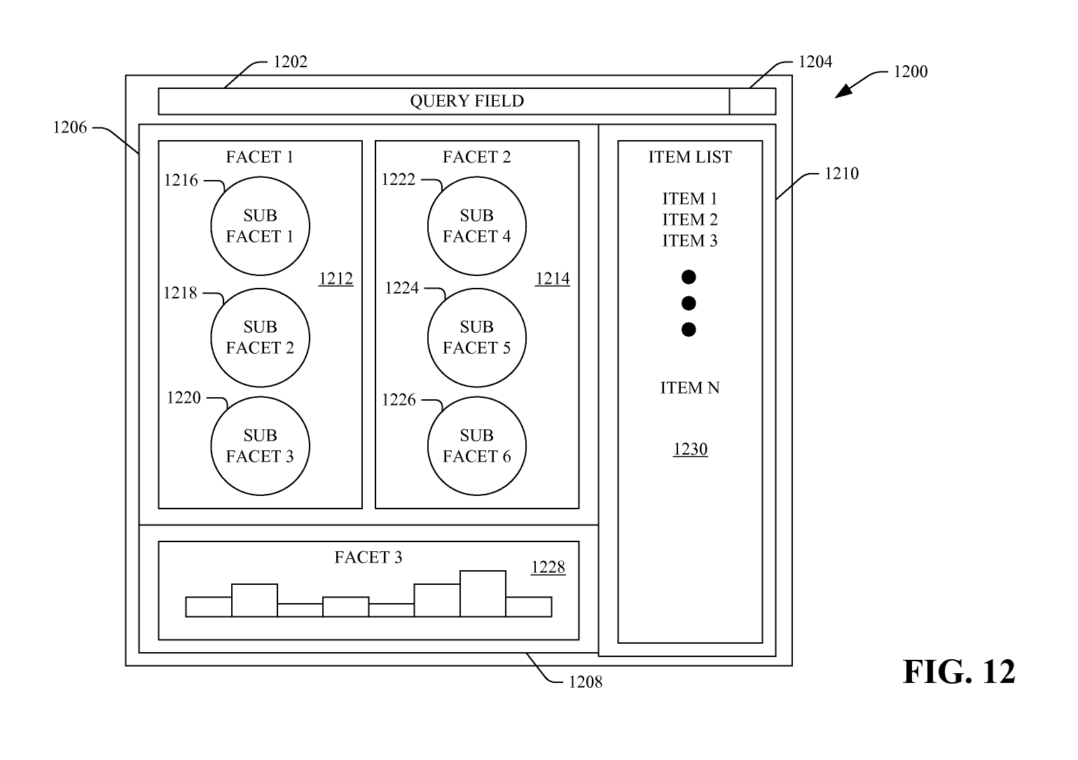

With reference now to FIG. 12, an example graphical user interface 1200 is illustrated. The interface 1200 includes a query field 1202 and a search button 1204, similar to what has been described above. The interface 1200 also includes a first facet field 1206, a second facet field 1208, and an items list field 1210. The first facet field 1206 includes facets 1212 and 1214, and sub-facets 1216, 1218, 1220, 1222, 1224, and 1226, which are similar to the facets in the field 1106 of the interface 1100 (FIG. 11).

The second facet field 1208 includes a facet 1228 that is similar to the facet 1134 depicted in FIG. 11. The items list field 1210 includes a list of items 1230 in the dataset, wherein displayed items in the list of items 1230 are a subset of items in the dataset. The list of items 1230 may be dynamically updated responsive to user input. For instance, if a user selects the facet 1216, the list of items 1230 may be updated to display items that correspond to the selected facet 1216. Similarly, if the user selects a selectable graphical icon of the facet 1228, the list of items 1230 can be updated to display items that correspond to the selected graphical icon.

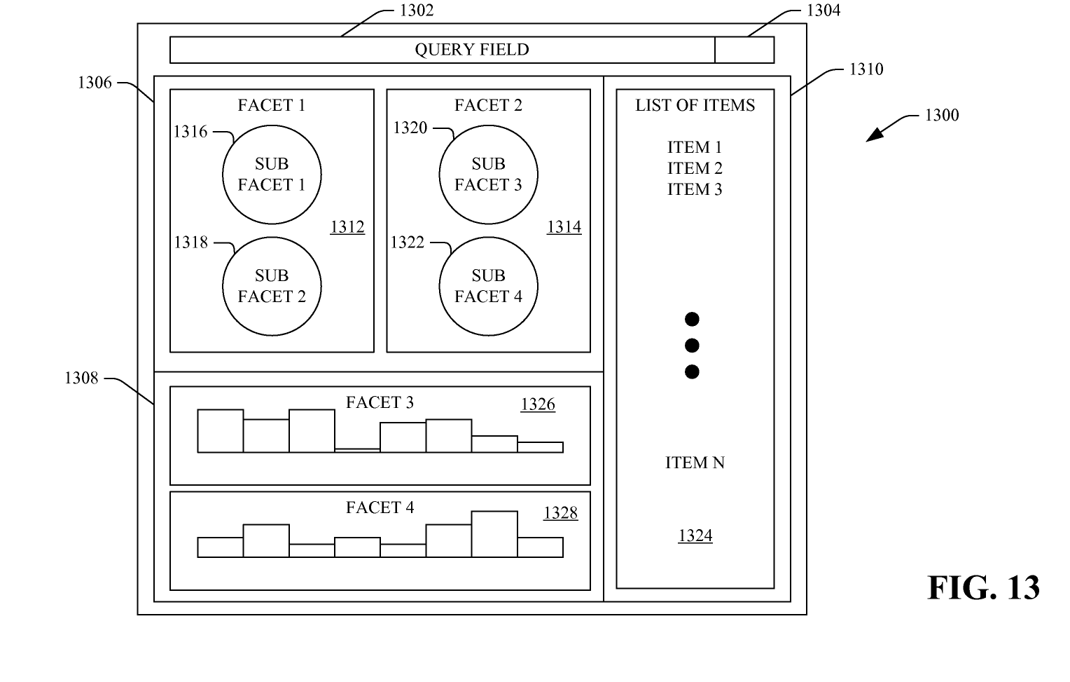

Turning now to FIG. 13, an example graphical user interface 1300 is illustrated. The interface 1300 includes a query field 1302 and a search button 1304. The interface 1300 further includes a first facet field 1306, a second facet field 1308, and an items list field 13 10. Facets and/or sub-facets 1312-1322 in the facet fields 1306 and 1308 are similar to facets and sub-facets described above. In addition, a list of items 1324 in the items list field 1310 is similar to the list of items described above.

The second facet field 1308 includes two facets 1326 and 1328 that are displayed such that an axis of the two-dimensional space is utilized to encode information pertaining to the facets 1326 and 1328 and/or the sub-facets of such facets. Pursuant to an example, the facets 1326 and 1328 may be assigned a collective title (e.g., such as a title that is indicative of a linear attribute used when rendering the facets 1326 and 1328). Furthermore, each of the facets 1326 and 1328 may have a title that describes contents of such facets 1326 and 1328, wherein such titles may be placed to the left or to the right of the facets 1326 and 1328. Such facets are similar to those depicted in FIGS. 11 and 12.

The example interface 1300 illustrates that two different facets can be displayed in a multi-dimensional manner in a particular field for sake of comparing a grouping of items within the two facets. For instance, the facet 1326 may represent papers written by an author A with respect to time while the facet 1328 represents papers written by another author B with respect to time. A user, reviewing the facet field 1308, can quickly compare two different facets with respect to a common linear attribute, for example.

Furthermore, in an example, a facet from the facet field 1306 may be selected and dragged to the facet field 1308, which may cause the facet to be rendered in a multi-dimensional manner. Thus, multiple facets may be displayed with respect to a common linear attribute in the facet field 1308. Furthermore, selecting and dragging a facet from the facet field 1306 into the facet field 1308 may cause a new window to be generated, and at least the selected facet from the facet field 1306 is depicted in the new window with respect to a linear attribute (wherein the linear attribute may be selected as an attribute that is desirably treated as linear by a user). In another example, the selected facet from the facet field 1306 may be displayed in a new window together with one or more facets from the facet field 1308 (e.g., with respect to a substantially similar linear attribute).

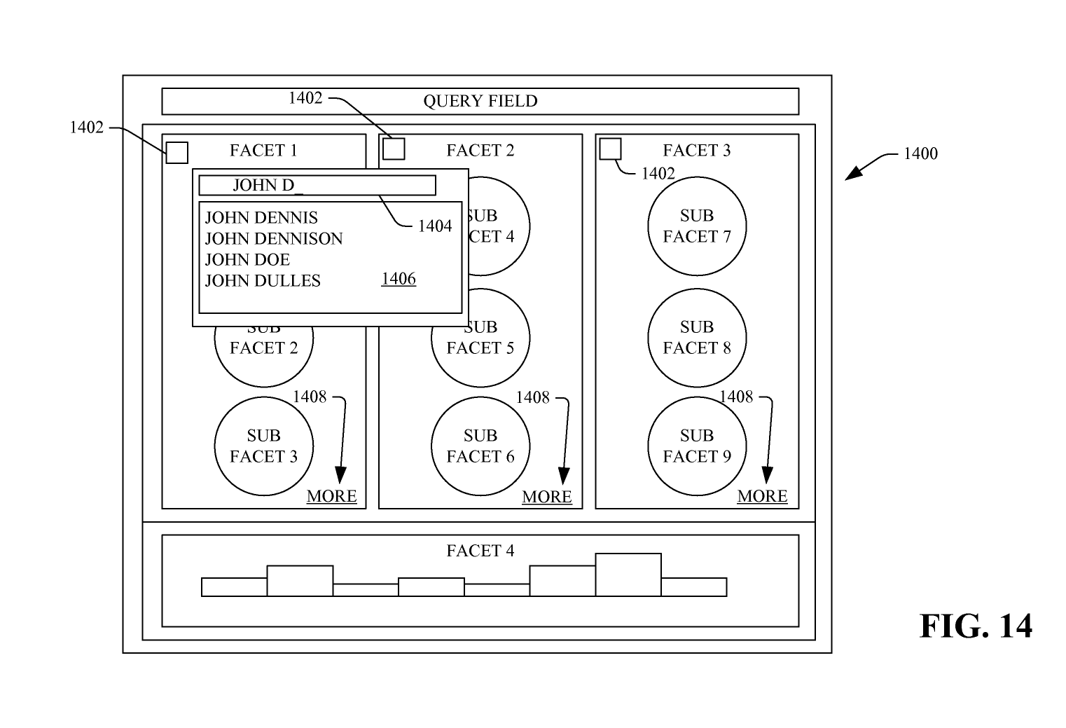

Now referring to FIG. 14, an example graphical user interface 1400 is illustrated. The interface 1400 is similar to the example interface 1100 (FIG. 11), and for the sake of brevity aspects described above will not be repeated. A subset of the facets and/or sub-facets in the graphical user interface 1400 include a query button 1402. Upon user selection of a query button, a query field 1404 is presented to the user, wherein the query field corresponds to a facet or sub-facet that includes the selected query button. The user may then begin typing a query into the query field 1404. A query presentation field 1406 may present facets and/or items that correspond to the query received by the query field 1404. The user may select one of the presented facets or sub-facets in the presentation field 1406, and a different graphical user interface may be generated.

In addition, as depicted, a facet may include several sub-facets, such that all sub-facets cannot be displayed. In such situations, a link 1408 (e.g., a “more” link) can be provided to the user for selection, wherein selection of such link may initiate presentation of additional sub-facets.

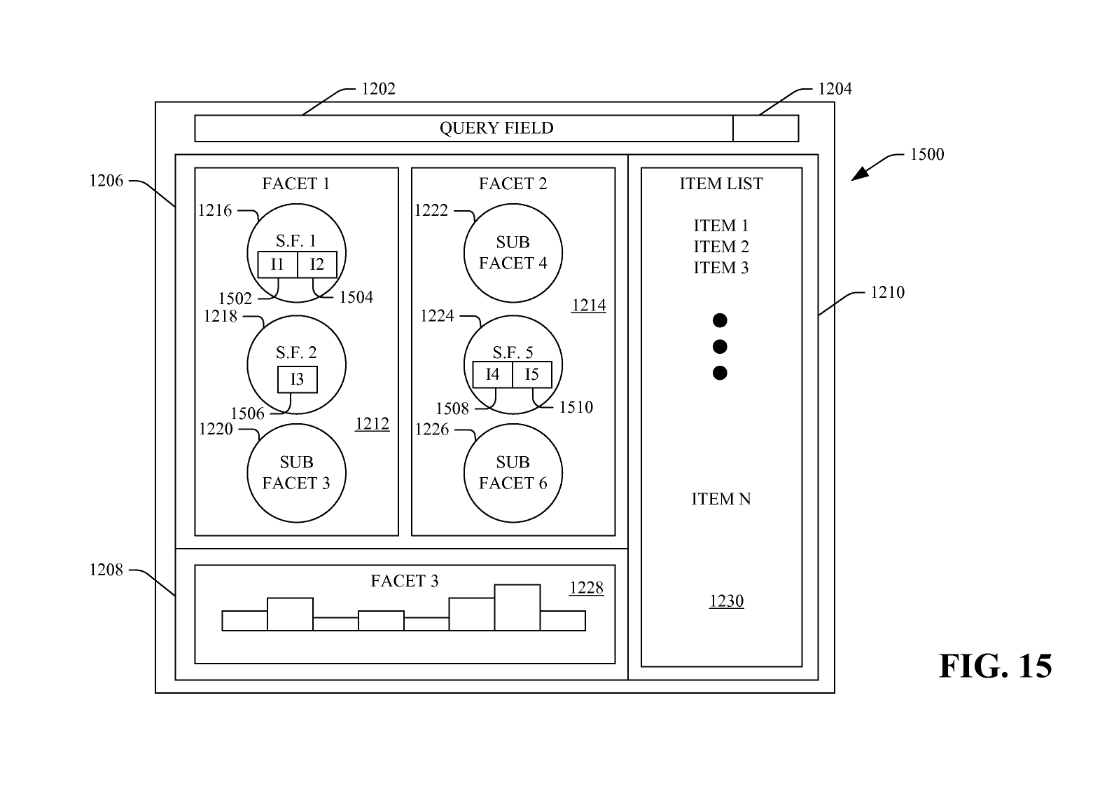

With reference now to FIG. 15, an example graphical user interface 1500 is illustrated. The graphical user interface 1500 is similar to the example graphical user interface 1200 (FIG. 12), and for the sake of brevity aspects described above will not be repeated. In this example graphical user interface 1500, the facet 1216 is depicting as including a first item 1502 and a second item 1504, the facet 1218 is depicted as including a third item 1506, and the facet 1224 is depicting as including a fourth item 1508 and a fifth item 1510. In this example interface 1500, the facets 1220, 1222, and 1226 may correspond to numerous items, wherein it may be undesirably to display each of such items in the facets.

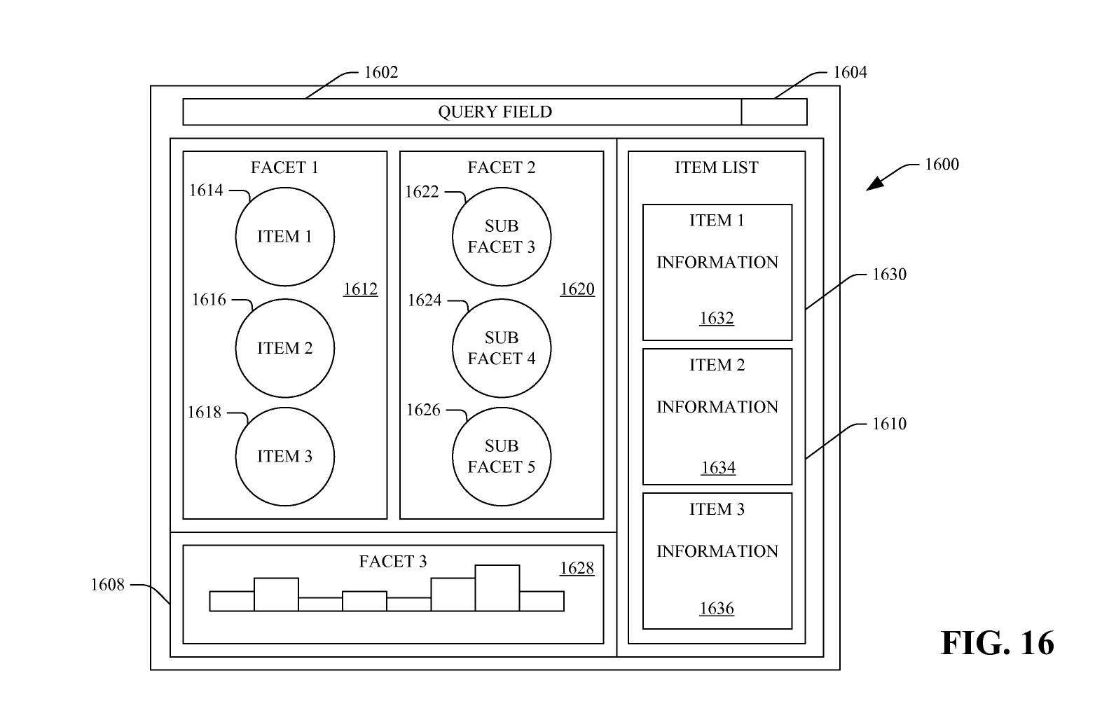

Referring to FIG. 16, an example graphical user interface 1600 is illustrated. The interface 1600 includes a query field 1602 and a search button 1604. The interface 1600 additionally includes a first facet field 1606, a second facet field 1608, and an item list field 1610. The first facet field 1606 includes a first facet 1612, wherein such facet 1612 is depicted as including three items 1614, 1616, and 1618. Such items, for example, may be the sole items remaining after a user has filtered a dataset by way of selection of facets and/or querying. The first facet field 1606 additionally includes a second facet 1620, which is depicted as including sub-facets 1622, 1624, and 1626. Selection of one of such facets and/or sub-facets 1620-1626 may initiate a new search over a dataset, for example.

The second facet field 1608 includes a facet 1628, wherein an attribute of the facet may be displayed with respect to a linear attribute.

The item list field 1610 includes a list of items 1630, which includes the first item 1614, the second item 1616, and the third item 1618. In addition to listing the item, due to an amount of space available in the item list field 1610, information with respect to the items 1614-1618 can be presented to the user. For instance, information fields 1632-1636 can be presented to the user, wherein such fields include information pertaining to the items 1614-1618 (e.g., information that is in addition to information that identifies the items 1614-1618). A size of an information field may correspond to available space in the items list field 1610. For instance, if five items were to be displayed in the items list field 1610, an amount of space for each information field would be less when compared to an amount of space for an information field if three items were to be displayed in the items list field 1610.

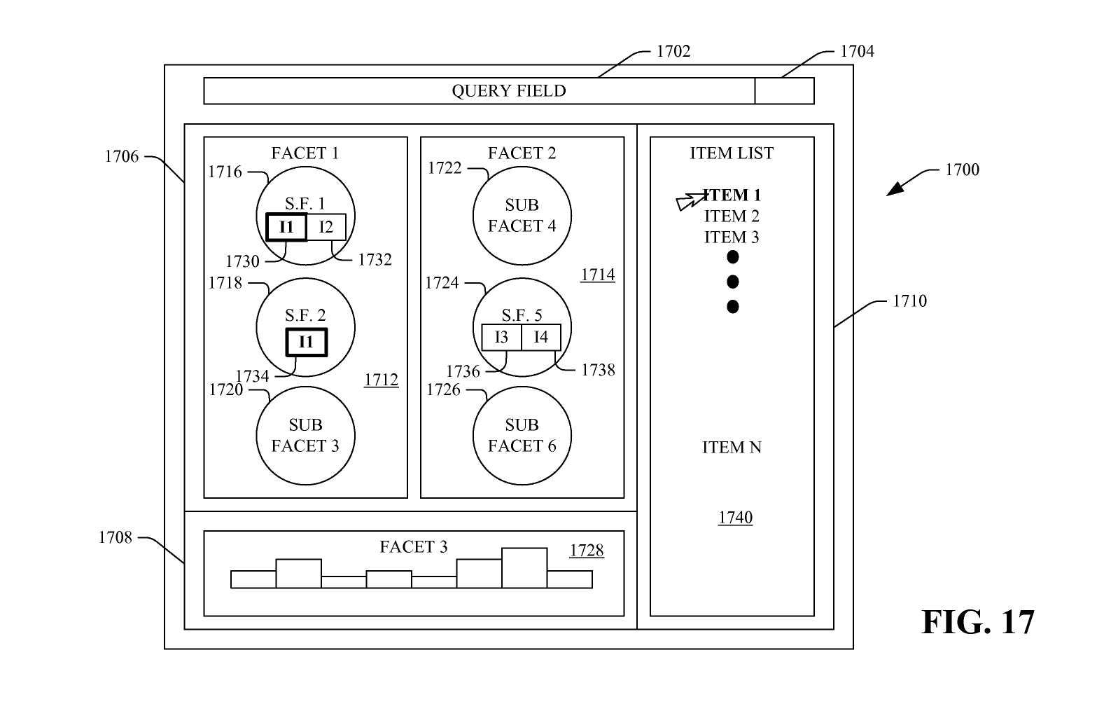

Referring now to FIG. 17, an example graphical user interface 1700 is illustrated. The interface 1700 includes a query field 1702 and a search button 1704. The interface 1700 additionally includes first facet field 1706, a second facet field 1708, and an item list field 1710. The first facet field 1706 includes a plurality of facets and sub-facets 1712-1726. The second facet field 1708 includes a facet 1728 that is displayed with respect to an attribute (e.g., an attribute selected to be a linear attribute).

The facet 1716 in the first facet field is rendered to include icons 1730 and 1732 that are representative of first and second items. The facet 1718 is rendered to include an icon 1734 that is representative of the first item. Additionally, the facet 1724 is rendered to include icons 1736 and 1738 that are representative of third and fourth items, respectively.

The items list field 1710 includes a list of items 1740, wherein items represented by the icons 1730-1738 are included in the list of items. A cursor 1742 is shown as hovering over the first item as rendered in the list of items 1740. Such hovering can result in the first item as rendered being highlighted when compared to other items in the list of items 1740. Additionally, such hovering may cause the icons 1730 and 1734 that are representative of the first item to be highlighted. While not shown, the cursor 1742 may be used to hover over one of the icons (e.g., the icon 1730). In such an instance, the icon 1730, the icon 1734, and the item as rendered in the list of items 1740 may be highlighted.

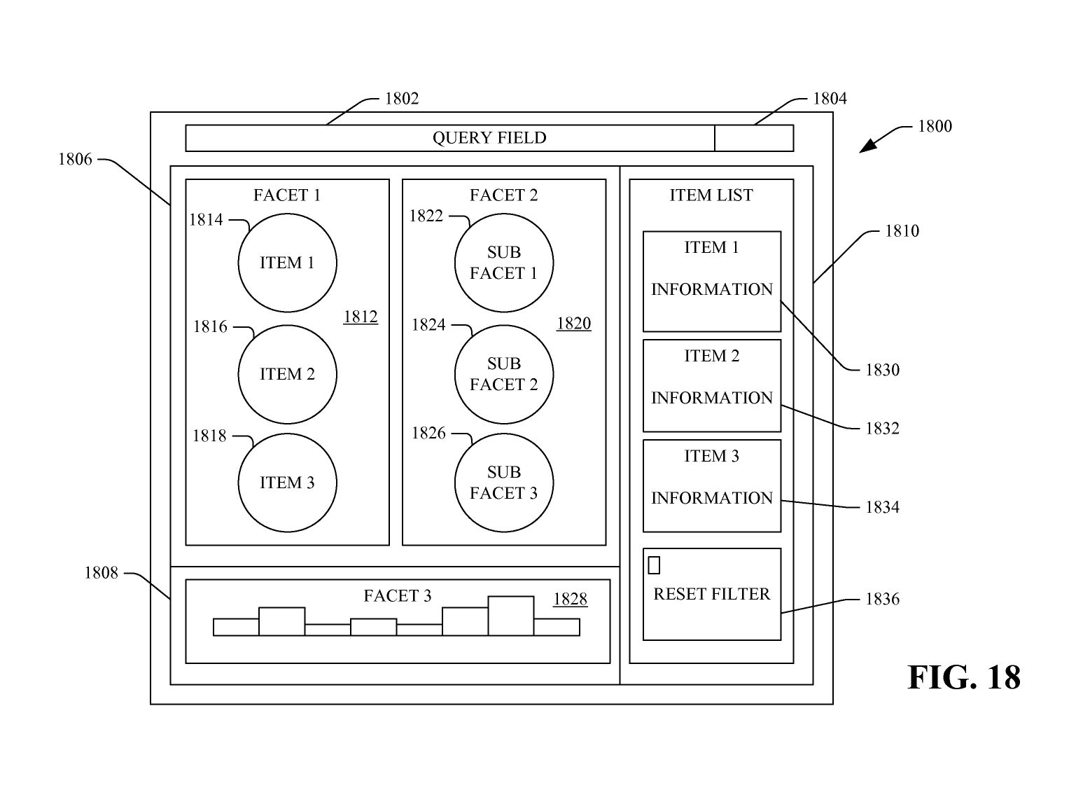

Now turning to FIG. 18, an example graphical user interface 1800 is illustrated. The interface 1800 includes a query field 1802 and a search button 1804. The interface 1800 additionally includes a first facet field 1806, a second facet field 1808, and an item list field 1810. The first facet field includes a first facet 1812 that is illustrated as comprising a plurality of items 1814, 1816, and 1818. The first facet field also includes facets 1820, 1822, 1824, and 1826, wherein the facets 1822, 1824, and 1826 are sub-facets of the facet 1820. The second facet field 1808 includes a facet 1828 that is represented as a plurality of selectable graphical icons. In an example, the facet 1828 may represent a first attribute with respect to a second, linear attribute such as time.

The item list field 1810 includes information fields 1830, 1832, and 1834 that present information pertaining to the items 1814, 1816, and 1818. The item list field 1810 additionally includes a pivot filter 1836. The pivot filter 1836 can present filter criteria that is related to current filter criteria (e.g., facet selections) that have been used to locate one or more of the items 1814-1818. Pursuant to an example, the items presented may be authors of a paper. The pivot filter 1836 may reset the filter to related filter criteria, such as “papers by author.” Selection of the pivot filter 1836, then, may initiate a search for items in the dataset that are papers prepared by at least one of the authors of the paper. Such items (or facets) may be presented to the user on a different graphical user interface.

In addition, filtering can be accomplished by filtering by an attribute of an item. For instance, one or more of the items 1814-1818 may be scholarly articles that have several attributes. These attributes may be displayed in the item list 1810. Upon selection of one of the attributes, contents of a dataset may be filtered by the selected attribute. In an example, the item 1814 may be a scholarly article that has a particular author. Upon selection of the author, for instance, content of the dataset may be filtered, such that the filtered set includes scholarly articles that are authored by the selected author.

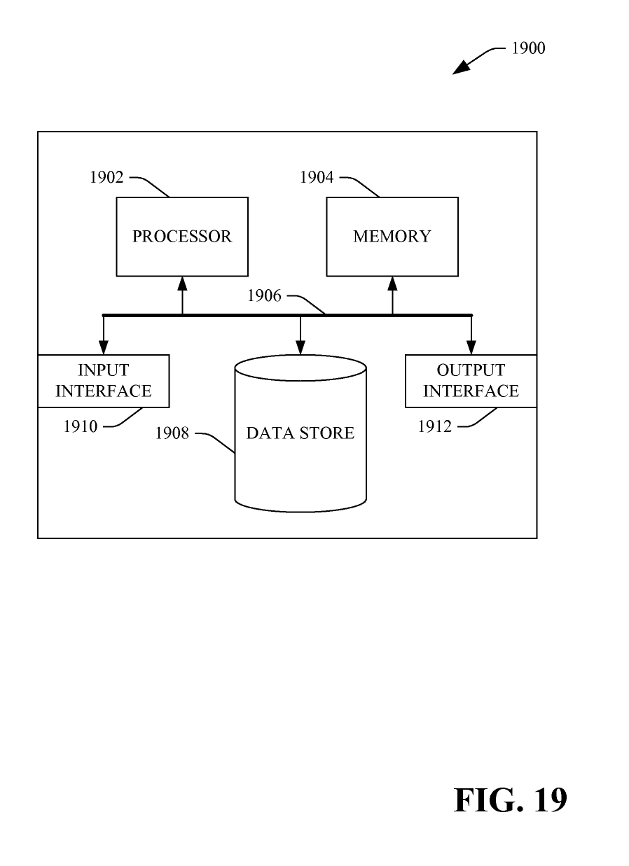

Now referring to FIG. 19, a high-level illustration of an example computing device 1900 that can be used in accordance with the systems and methodologies disclosed herein is illustrated. For instance, the computing device 1900 may be used in connection with visual search system, such as a system that facilitates search by way of facets. Accordingly, the computing device 1900 may be or be included within a server system. In another example, the computing device 1900 may be or be included in a client device, such as a desktop computer, a laptop computer, a personal digital assistant, and the like. The computing device 1900 includes at least one processor 1902 that executes instructions that are stored in a memory 1904. The instructions may be, for instance, instructions for implementing functionality described as being carried out by one or more components discussed above or instructions for implementing one or more of the methods described above. Additionally or alternatively, the instructions may be instructions for rendering graphical user interfaces, such as the example graphical user interfaces described above. The processor 1902 may access the memory by way of a system bus 1906. In addition to storing executable instructions, the memory 1904 may also store items, relationships between items, metadata, etc.

The computing device 1900 additionally includes a data store 1908 that is accessible by the processor 1902 by way of the system bus 1906. The data store 1908 may include executable instructions, items, relationships, attributes, etc. The computing device 1900 also includes an input interface 1910 that allows users or external devices to communicate with the computing device 1900. For instance, the input interface 1910 may be used to receive instructions from an external computer device, input or commands from a user, etc. The computing device 1900 also includes an output interface 1912 that interfaces the computing device 1900 with one or more external devices or allows information to be provided to a user. For example, the computing device 1900 may display images, facets, search results, or the like by way of the output interface 1912.

Additionally, while illustrated as a single system, it is to be understood that the computing device 1900 may be a distributed system. Thus, for instance, several devices may be in communication by way of a network connection and may collectively perform tasks described as being performed by the computing device 1900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Further, a component may be computer-executable.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system that comprises the following computer-executable components:
a receiver component that receives a dataset and defined relationships amongst data in the dataset, wherein the relationships are indicative of identities of a plurality of facets in the dataset, wherein each facet includes an item, and wherein items in a facet have a common attribute; and
a renderer component that concurrently
a) renders a first facet in the plurality of facets on a graphical user interface, wherein the first facet is rendered as a selectable graphical icon; and
b) renders a second facet in the plurality of facets on the graphical user interface, wherein the second facet is rendered with respect to a linear attribute.

2. The system of claim 1, wherein the renderer component renders the second facet to illustrate a number of items in the second facet with respect to the linear attribute.

3. The system of claim 1, wherein the renderer component renders the second facet to illustrate a number of items in the second facet with respect to time or different spatial locations.

4. The system of claim 1, further comprising:
a query component that receives a textual query from a user;
an interface component that receives a user selection of at least one facet from amongst a plurality of displayed facets; and
an executor component that searches the at least one selected facet using the received textual query.

5. The system of claim 1, further comprising a lister component that generates a list of items in the dataset, wherein the renderer component renders a subset of the items in the dataset in list form on the graphical user interface.

6. The system of claim 1, further comprising a selection receiver component that receives a user selection of the first facet, wherein the first facet includes a plurality of sub-facets, and wherein the renderer component renders a subset of the plurality of sub-facets on a graphical user interface in response to the user selection of the first facet.

7. The system of claim 1, further comprising:
a query component that receives a textual query from a user; and
an executor component that uses the textual query to search the dataset, wherein the renderer component renders one or more of a facet or an item on the graphical user interface based at least in part upon the textual query.

8. The system of claim 1, wherein each facet includes at least one item, and wherein the renderer component graphically illustrates at least one item in at least one facet as a graphical icon.

9. The system of claim 8, further comprising a detector component that detects that an item is being hovered over, wherein multiple representations of the item are depicted on the graphical user interface, and wherein the renderer component highlights each of the multiple representations of the item on the graphical user interface based at least in part upon the detection.

10. The system of claim 1, further comprising:
a selection detector component that detects that an item in a facet has been selected;
a provider component that provides one or more attributes that can be used as a search filter, wherein the one or more attributes correspond to the selected item; and
a filter component that filters the dataset based at least in part upon a user selection of one of the one or more attributes.

11. The system of claim 1, further comprising a size determiner component that determines an amount of real estate used to display the first facet, wherein the renderer component renders an amount of detail corresponding to the first facet to render based at least in part upon the determined amount of real estate.

12. The system of claim 1, wherein the first facet includes a plurality of items, and wherein in response to user-selection of the first facet, the renderer component renders a subset of the plurality of items concurrently with trend data corresponding to the first facet.

13. The system of claim 1, further comprising a combiner component that receives an indication that a user has selected the first facet and dragged it over a rendered attribute of the second facet, wherein contents of the first facet are filtered by the attribute of the second facet.

14. A method comprising the following computer-executable acts:
receiving a dataset that includes a plurality of facets, wherein each facet includes at least one item and each item includes at least one attribute, and wherein items in a facet share at least one common attribute;
rendering a first facet on a graphical user interface, wherein the first facet is represented as a selectable graphical icon; and
concurrently with rendering the first facet, rendering a second facet on the graphical user interface, wherein the second facet is represented as a plurality of selectable graphical icons with respect to a linear attribute.

15. The method of claim 14, further comprising:
receiving an indication that the first facet has been selected by a user;
filtering the dataset based at least in part upon the received indication; and
graphically rendering a third facet on the graphical user interface, wherein the third facet is a sub-facet of the first facet.

16. The method of claim 15, further comprising graphically rendering a fourth facet such that the fourth facet is displayed concurrently with the third facet, wherein the fourth facet is rendered to represent an attribute with respect to the linear attribute.

17. The method of claim 14, further comprising:
receiving an indication that the first facet is selected and dragged over one of the plurality of icons that represent the second facet; and
filtering the dataset based at least in part upon an attribute corresponding to the first facet and an attribute corresponding to the second facet.

18. The method of claim 14, wherein the first facet includes an item, and further comprising displaying information corresponding to the item in the first facet.

19. The method of claim 18, wherein the item is displayed as a graphical icon in the first facet.

20. A graphical user interface, comprising:
a first field that comprises a first facet, wherein the first facet includes a first plurality of items from a dataset, wherein each of the items in the first facet include a common attribute, wherein the first facet is displayed as a selectable graphical icon;
a second field that comprises a second facet, wherein the second facet includes a second plurality of items from a dataset, wherein each of the items in the second facet include a common attribute, wherein the second facet is displayed to represent a number of items that include the common attribute with respect to a linear attribute; and
a third field that comprises a list of items in the dataset, wherein the list of items lists a subset of items in the dataset.
